(19) United States
(12) Patent Application Publication
(10) Pub. No.: US 2012/0092966 A1
(43) Pub. Date: Apr. 19, 2012

(54) CLOCK DEVICE AND METHOD FOR PROCESSING A CLOCK DEVICE

(75) Inventors: Jia Du, Eindhoven (NL); Adrianus Sempel, Waalre (NL); Petronella Hendrika Zwartkruis-pelgrim, Eindhoven (NL); Vicentius Paulus Buil, Eindhoven (NL)

(73) Assignee: KONINKLIJKE PHILIPS ELECTRONICS N.V., EINDHOVEN (NL)

(21) Appl. No.: 13/378,135

(22) PCT Filed: Jun. 10, 2010
(86) PCT No.: PCT/IB2010/052582

§ 371 Date: Dec. 14, 2011

(30) Foreign Application Priority Data
Jun. 15, 2009 (EP) 09162729.9

(51) Int. Cl. G04B 47/00; G04B 19/00

(52) U.S. Cl. 368/10; 368/223

(57) ABSTRACT

The present invention relates to a clock device and a method for processing a clock device, wherein the clock device comprises a control unit which operates a display unit in a first operating mode or in a second operating mode, wherein the display unit displays the exact current time in the second operating mode and fades out the exact current time in the first operating mode.

### FIELD OF THE INVENTION

The present invention relates to the field of alarm clocks and timepieces for displaying the actual daytime.

### BACKGROUND OF THE INVENTION

Clocks with physical hands and/or digital number displays are known for a long time and widely used among different kinds of clocks and watches, e.g. alarm clocks and wrist watches. It is also common knowledge to provide alarm clocks which have a time displaying section that is illuminated when an illumination switch is turned on by the user and that the illuminating switch can be manually turned off to darken the displaying section when the user is trying to fall asleep, for instance. There are also alarm clocks comprising a light sensor to measure the luminosity of ambient light which turns on the illumination of the display section when the luminosity of the ambient light falls below a certain threshold. Furthermore, the prior art document U.S. Pat. No. 5,359,577 A discloses an alarm clock with a display section for displaying the actual daytime. The illumination of the displaying section is controlled in such a manner that the displaying section is illuminated only when the current time is within a predetermined time zone before the alarm time set by the user.

In WO 2009/030882 A2 o'clock, especially for young children, is disclosed. The clock displays a first image to indicate a first time period and a second image to indicate a second time period. For example a moon is displayed for indication of sleep time and a sun is displayed for wake time. In one embodiment the first image undergoes a series of discrete changes at appropriate intervals throughout a user-selected sleep time period. A user may then readily tell from the first image, what proportion of the selected period has elapsed. Further the second image may include an image of the sun with a plurality of rays around it and the rays may turn appear, disappear to indicate the passage of intervals of time. Further the device is able to display a traditional numerical time output should the user wish to check the time of day.

DE 20 2004005764 U1 discloses a programmable clock with wake up function. Awake up signal is generated under respect of the actual sleep phase and the predetermined wake up time.

In accordance with the prior art, the users of the above mentioned alarm clocks are able to recognize the current daytime during their bedtime, or in the case of the children's clock, only two different time periods are indicated.

This is prejudicial for the sleeping behaviour of many users with sleeping disorders. In particular if these users trying to fall asleep, because from previous user research with busy adults who have sleep related issues, it was found that knowing the exact time while not being able to fall asleep makes people more stressed at night. When people start worrying about too little remaining time and/or continuously decreasing time they could sleep, they get even more irritated and it makes falling asleep difficult. In order to cope with this, people try to ignore looking at the time and some even cover the clock to prevent themselves from knowing the actual time. However, in the morning, when people need to wake up in time for their work, knowing the exact time is essential. In addition, many people, especially those who are concerned with their sleep or suffer from insomnia often underestimate their actual sleeping hours. Once these people come to sleep centre and have their sleep monitored, the results show that they slept much longer than they perceived. The miss perception on sleep quality and quantity can bring negative influences on people's sleep. It may even cause depression over a long time.

### SUMMARY OF THE INVENTION

It is an object of the present invention to increase the sleep quality of people using alarm clocks by fading out the exact current time during bedtime and displaying the current time in the morning or in the day.

The above mentioned object is accomplished by a clock device for a user comprising a display unit for displaying the current time and a control unit for triggering the display unit, wherein the display unit is triggered by the control unit in such a manner, that in a first operation mode during bedtime, sleeping and/or falling asleep of the user the exact current time is faded out.

The present invention proposes a clock device, in particular a personal timepiece, an alarm clock, a wrist watch, a digital clock, an analog clock or the like, that fades out the exact current time during bedtime of the user. In the sense of the present invention the wording exact current time means preferably displaying the daytime exact-to-the-second, exact-to-the-minute and/or exact-to-the-hour. If the exact current time, which is very important for the user in the morning and in the day, is faded out during bedtime, the user trying to fall asleep does not know the exact time and therefore feels more relaxed and unstressed. In particular, the user is not able to calculate how many sleeping time is left and in how many hours or minutes he has to get up. Fading out the exact current time in the first operation mode preferably means that either the display unit is not illuminated or the current time is not displayed by the display unit. In particular, the user is not able to fade in the current time during bedtime. A user-driven switching between the first and the second operating mode is disabled at least in the first operating mode or a possible illumination switch for turning on the illumination of the display unit are disabled, for instance. Preferably the display unit shows the sleep time progression of the user in the first operating mode. The wording daytime in the sense of the present inventions means the time, when the user has to be awake or woken up. This could also be during night, for instance. In the same way, the bedtime could also be during the day, if the user relaxes during the day or takes a nap, for example.

Another object of the present invention is a method for processing a suchlike clock device comprising the steps of displaying the current time in a second operating mode, fading out the current time in a first operating mode, wherein the first operating is enabled during bedtime, sleeping or falling asleep of the user.

In a preferred embodiment of the present invention the first operating mode automatically changes into a second operating mode of the clock device during wake up time of the user, wherein the wake up time is preset by the user. In the second operating mode the current time is displayed in a common way, exact-to-the-second, exact-to-the-minute and/or exact-to-the-hour. The current time is visualized by an analog or a digital clock, for example.

In another preferred embodiment of the present invention the display unit shows a visual pattern in the first operating mode which slightly represents the current time. The visual pattern preferably comprises a dynamical and/or abstract graphical illustration, wherein the current time is represented using a histogram, different colors, different geometrical shapes, different pictures or the like. In a preferred embodiment the visual pattern shows the moon phases which changes in dependency of the varying nighttime. Advantageously, the user could only roughly approximate the current time and does not get information about the exact hour or minutes of the actual time. By way of example, the user just gets an unobtrusive note if the actual point of time is within the first half of the bedtime or in the second half of the bedtime. Furthermore, it is possible to roughly represent the actual time in the first operating mode by using the size of a balloon which is blown up in dependency of the actual time and which preferably bursts when the user has to get up.

In another preferred embodiment of the present invention comprises a sensor unit for sensing the actual sleeping status of the user, wherein the display unit is triggered by the sensor unit. Advantageously, the operating mode of the display unit is selected in dependency of the actual sleeping status of the user. For example, if the user is tired, shortly before falling asleep or already sleeping the first operating mode is enabled. For accurately determining the user's sleeping status, the sensor unit preferably comprises a temperature sensor, an actigraph, a pulse monitor, a blood pressure monitor, a microphone, a force sensor, a camera, an electrocardiograph, an electroencephalograph, galvanic skin response detector or the like.

In a preferred embodiment the sensor unit also measures external events and triggers the display unit in dependency of possible external events. If the sensor unit detects an external event, like a sound, warning or emergency signal, ringing phone, luminosity of ambient light or the like, the display unit is switched into the second operating mode to show the exact daytime to the waking up user.

Preferably, the clock device comprises a memory unit for storing a sleeping pattern of the user, which entered by the user via a user-interface, measured by the sensor unit and/or extracted from the preset wake up time. Advantageously, the switching between the first and the second operating mode is accomplished in dependency of this sleeping pattern. The first operating mode is enabled when the user usually goes to bed and the second operating mode is enabled shortly before the user usually wakes up, for instance.

These and other characteristics, features and advantages of the present invention will become apparent from the following detailed description, taken in conjunction with the accompanying drawing, which illustrates, by way of example, the principles of the invention. The description is given for the sake of example only, without limiting the scope of the invention. The reference figures quoted below refer to the attached drawing.

### BRIEF DESCRIPTION OF THE DRAWINGS

FIG. 1 shows a clock device according to a first embodiment of the present invention;

FIG. 2 shows a clock device according to a second embodiment of the present invention;

FIG. 3 shows a clock device according to a third embodiment of the present invention;

FIG. 4 shows a clock device according to a fourth embodiment of the present invention and

FIG. 5 shows a clock device according to a fifth embodiment of the present invention.

### DETAILED DESCRIPTION OF EMBODIMENTS

The present invention will be described with respect to particular embodiments and with reference to a certain drawing but the invention is not limited thereto but only by the claims. The drawing described is only schematic and is non-limiting. In the drawing, the size of some of the elements may be exaggerated and not drawn on scale for illustrative purposes.

Where an indefinite or definite article is used when referring to a singular noun, e.g. “a”, “an”, “the”, this includes a plural of that noun unless something else is specifically stated. Furthermore, the terms first, second, third and the like in the description and in the claims are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein. Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein. It is to be noticed that the term “comprising”, used in the present description and claims, should not be interpreted as being restricted to the means listed thereafter; it does not exclude other elements or steps. Thus, the scope of the expression “a device comprising means A and B” should not be limited to devices consisting only of components A and B. It means that with respect to the present invention, the only relevant components of the device are A and B.

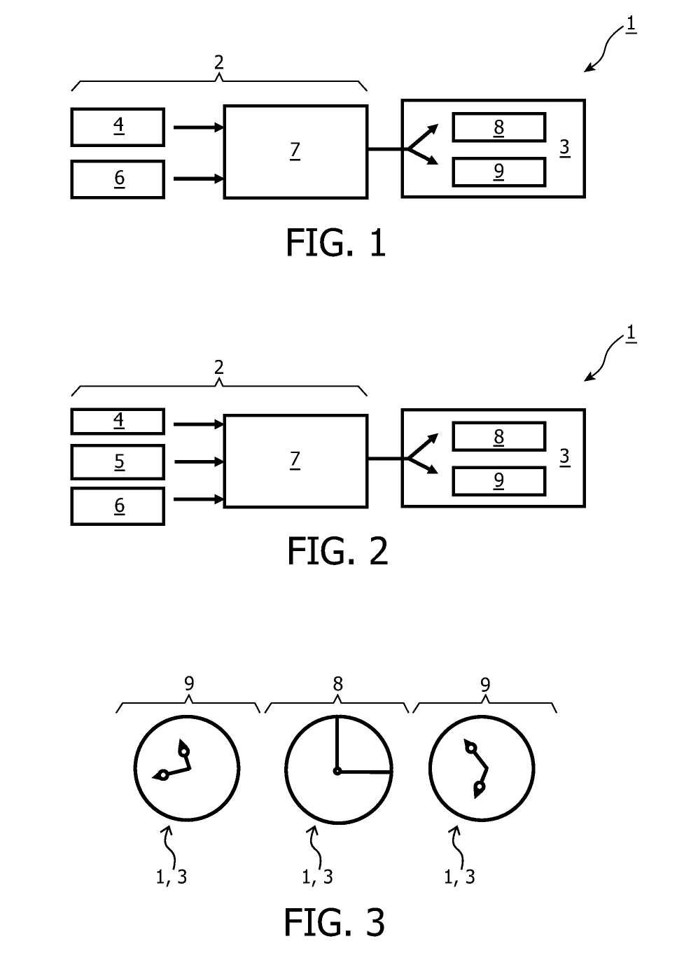

FIG. 1 shows a clock device 1 according to a first embodiment of the present invention. The clock device 1 comprises a display unit 3 and a control unit 2. The control unit 2 consists of a processing unit 7 which is connected to a time generator 4 and a memory unit 6. The time generator 4 permanently generates the exact current time, which could be displayed to a user by the displacing unit 2. The memory unit 6 stores personal information of the user. Personal information could be a certain wake up time, a start and an end time of a user preferred bedtime interval and/or a complex sleeping pattern. The display unit 3 is designed to run in two different operating modes 8, 9. In a second operating mode 9 the display unit 3 exactly displays the current time generated by the time generator 4 in a common way as a digital or an analog clock, for instance. Therefore, the user can easily recognize the exact daytime exact-to-the-minute by looking at the display unit 3. If the display unit 3 operates in a first operating mode 8, the display unit 3 does not display the time. FIG. 2 shows a clock device 1 according to a second embodiment of the present invention. The clock device 1 comprises a display unit 3 and a control unit 2. The control unit 2 consists of a processing unit 7 which is connected to a time generator 4, a sensor unit 5 and a memory unit 6. The time generator 4 permanently generates the exact current time which could be displayed to a user by the displacing unit 2. The memory unit 6 stores personal information of the user. Personal information could be a certain wake up time, a start and an end time of a user preferred bedtime interval and/or a complex sleeping pattern. The sensor unit 5 is provided to detect the actual sleeping status of the person and preferably comprises an actigraph which measures body movements of the user. The control unit 2 determines certain sleep stages of the user from the measured body movements. The display unit 3 is designed to run in two different operating modes 8, 9. In a second operating mode 9 the display unit 3 exactly displays the current time generated by the time generator 4 in a common way as a digital or an analog clock, for instance. Therefore, the user can easily recognize the exact daytime exact-to-the-minute by looking at the display unit 3. If the display unit 3 operates in a first operating mode 8, the display unit 3 does not display the time.

During wake up time or during daytime the display unit 3 operates in the second operating mode 9, like a common alarm clock. In the bedtime of the user the control unit 2 enables the first operating mode 8 of the display unit 3. This is done by the control unit 2 which permanently monitors the current time and switches the operating mode when the current time reaches a preset bedtime. The bedtime is manually entered in the clock device 1 by the user via a user-interface and stored in the memory unit 6, for example. Alternatively, the first operating mode 8 is enabled in dependency of a measuring signal of the sensor unit 5 which detects sleeping or tiredness of the user. Preferably, the first operating mode 8 is started when the user fall asleep. In the first operating mode 8 the user could not manually switch the display unit 3 into the second operating mode 9 to get the exact current daytime. The second operating mode 9 is automatically enabled shortly before the wake up time. Preferably, the sensor unit 5 also detects external events, like phone ringing or acoustic emergency signals, and consequently enables the second operating mode 9.

FIG. 3 shows a display unit 3 of a clock device 1 according to an embodiment of the present invention. In the first illustration of FIG. 3 the second operating mode 9 is enabled and the display unit 3 shows an analog clock with moving hands representing the exact current time. During night, illustrated in the second illustrations of FIG. 2, the first operating mode 8 is disabled. The display unit 3 fades out the exact time. When it is time to get up, the display unit 3 is switched in the second operating mode 9 by the control unit 3 and shows the accurate time, demonstrated in the fourth illustration of FIG. 2.

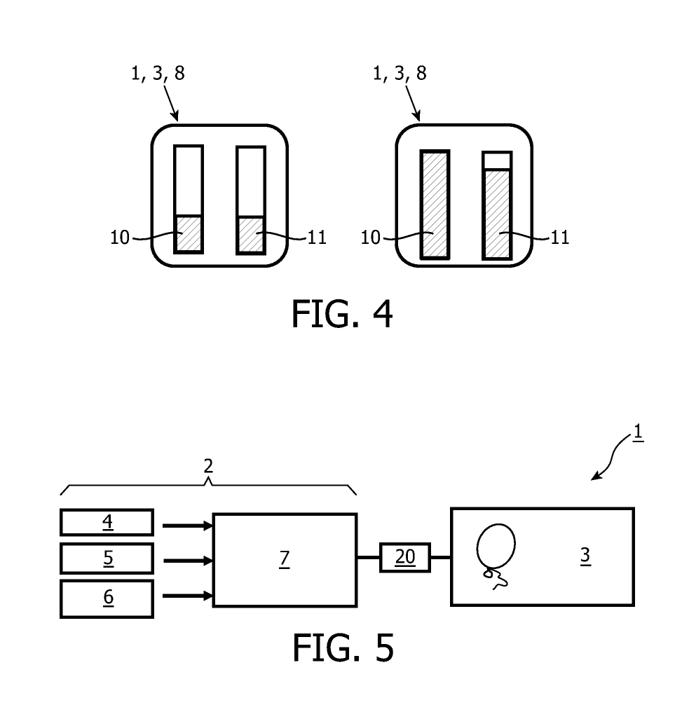

FIG. 4 show a display unit 3 operating in the first operating mode 8 of clock device 1 according to another embodiment of the present invention, wherein the display unit 3 displays a histogram with a first and a second bar 10, 11. The first bar 10 represents the actual time the user already spends in his bed and the second bar 11 represents the actual sleeping time of the user which is measured by the aid of the sensor unit 5 and the time generator 4. The first illustration of FIG. 4 shows the first and the second bar 10, 11 in the beginning of the night and the second illustration of FIG. 4 at wake up time. The user is now able to see his or her sleep quality and quantity at a simple glance.

FIG. 5 shows a clock device 1 according to a fifth embodiment of the present invention, wherein the fifth embodiment is substantially equal to the first embodiment illustrated in FIG. 1, wherein the display unit 5 comprises a balloon. When the user falls asleep the first operating mode 8 is enabled and the display unit 5 starts to pump up the balloon with a pump 20 in such a manner, that the balloon explodes when the user needs to get up in the morning. The sleep time progression is represented by the size of the balloon.

1. A clock device (1) comprising a display unit (3) for displaying the current time and a control unit (2) for triggering the display unit (3), wherein the display unit (3) is triggered by the control unit (2) in such a manner, that in a first operation mode (8) during bedtime of a user the current time is faded out and in a second operation mode (9) during daytime the exact current time is displayed.

2. A clock device (1) according to claim 1, characterized in that the display unit (3) is configured to represent the current time in the second operating mode (9) more accurate than in the first operating mode (8).

3. A clock device (1) according to claim 1, characterized in that the display unit (3) is configured to display a visual pattern (12) in the first operating mode (8), which represents the sleep time progression of the user.

4. A clock device (1) according to claim 1, characterized in that the clock device (1) comprises a sensor unit (5) for sensing the current sleeping status of the user, wherein the display unit (3) is triggered in dependency of the sensor unit (5).

5. A clock device (1) according to claim 4, characterized in that the sensor unit (5) comprises a temperature sensor, an actigraph, a pulse monitor, a blood pressure monitor, a microphone, a force sensor, a camera, an electrocardiograph, an electroencephalograph, galvanic skin response detector or the like.

6. A clock device (1) according to claim 1, characterized that the clock device (1) comprises a memory unit (6) for storing a personal sleeping pattern and/or wake up time of the user, wherein the display unit (3) is triggered in dependency of the memory unit.

7. A clock device (1) according to claim 6 characterized in that the clock device (1) comprises a user-interface for preset the memory unit (6) and/or the control unit (2), wherein in the first operating mode (8) the user-interface is at least partly locked against user input.

8. A method for processing a clock device (1) for a user comprising the steps of displaying the exact current time in a second operating mode (9) and fading out the current time in a first operating mode (8), wherein the first operating mode (8) is enabled during bedtime and the second operating mode (9) is enabled during daytime and/or wake up time of the user.

9. A method according to claim 8 characterized in that in the first operating mode (8) a visual pattern (12) is shown which slightly depends on the sleep time progression of the user.

10. A method according to claim 8 characterized in that in the second operating mode (9) the exact current time is displayed to-the-hour, to-the-minute and/or to-the-second, wherein in the first operating mode (8) the current time is represented less accurate than in the second operating mode (9).

11. A method according to claim 8 characterized in that a user-driven switching from the first operating mode (8) in the second operating mode (9) is disabled during bedtime, sleeping or falling asleep of the user.

12. A method according to claim 8 characterized in that the switching between the first and the second operating mode (8, 9) depends on a preset bedtime, on a sleeping pattern and/or on a preset wake up time.

13. A method according to claim 12, characterized in that the sleeping pattern is determined in dependency of the preset wake up time and/or a preset bedtime.

14. A method according to claim 8 characterized in that the switching between the first and the second operating mode (8, 9) depends on the current sleeping status of the user.

15. A method according to claim 14, wherein the current sleeping status of the user is determined by measuring current sleeping phase, temperature, body movement, heart rate, blood pressure, electrical heart activity, electrical brain activity, galvanic skin response or the like.
